(19) United States
(12) Patent Application Publication
(10) Pub. No.: US 2026/0007991 A1
(43) Pub. Date: Jan. 8, 2026

(54) MOISTURE CENTRIFUGE DRYER

(71) Applicant: MDX Co.,Ltd., Gangneung-si (KR)

(72) Inventor: Eun Hye SEO, Gangneung-si (KR)

(21) Appl. No.: 18/791,548

(22) Filed: Aug. 1, 2024

(30) Foreign Application Priority Data
Jul. 8, 2024 (KR) 10-2024-0089519

(51) Int. Cl. B01D 45/16; B01D 46/30; B01D 50/20; B01D 53/26

(52) U.S. Cl. CPC B01D 45/16; B01D 46/30; B01D 50/20; B01D 53/26; B01D 2257/80; B01D 2258/06

(57) ABSTRACT

Provided is a moisture centrifuge dryer capable of removing moisture contained in compressed air by using centrifugation without using an additional desiccant and which is permanently usable without replacing desiccant. The moisture centrifuge dryer includes a moisture removing part connected to a head part of an air compressor to remove moisture from compressed air introduced therein; and a compressed-air discharge part coupled to an upper end of the moisture removing part and connected to an air tank of the air compressor to guide the compressed air discharged upward from the moisture removing part, thereby discharging the compressed air toward the air tank, wherein the moisture removing part is configured to centrifugate moisture from the compressed air to remove the moisture from the compressed air.

### CROSS-REFERENCE TO RELATED APPLICATION

This application claims priority to Korean Patent Application No. 10-2024-0089519 filed on Jul. 8, 2024 and all the benefits accruing therefrom under 35 U.S.C. § 119, the contents of which are incorporated by reference in their entirety.

### BACKGROUND

The present disclosure relates to a moisture centrifuge dryer, and more particularly, to a moisture centrifuge dryer mounted on an air compressor to remove moisture contained in compressed air.

In general, an air compressor is an essential power source used across various industries, including semiconductor and chemical processes, medical equipment, environmental equipment, and so on. Due to its advantages, such as ease of use, storage convenience, and safety, the air compressor is widely utilized in most production plants. Compressed air is also convenient to handle, making it applicable not only in the aforementioned industries but also in mechanical engineering, civil engineering, and all other industries using mechanical tools, as well as in various processes in chemical industries and steel mills.

An air compressor consists of a head part that generates compressed air and an air tank where the compressed air generated from the head part is stored.

The air compressor compresses air and cools the high-temperature compressed air, and then stores it in the air tank.

Here, during the cooling process of the compressed air, water is generated, resulting in the storage of compressed air containing moisture inside the air tank.

However, it may lead to corrosion and rust inside the tank, and thus, the compressed air stored inside the air tank is contaminated.

Particularly, the air compressor used in facilities requiring strict hygiene, such as dental clinics, where it is crucial to generate dehydrated clean compressed air.

When compressed air containing moisture is stored in the air tank and thus is contaminated, there have been issues that posed a risk to the patient's health, during patient treatment, the contaminated compressed air could be sprayed into the patient's mouth.

Furthermore, since a large amount of moisture is contained in the compressed air, during the treatment, a portion to where the compressed air is sprayed is not completely dried, and thus the bonding force of dental restorative materials is reduced.

Also, since a dental equipment operates using pneumatic pressure, if compressed air containing moisture is supplied into the dental equipment, the moisture penetrates inside the equipment to degrade the durability or cause malfunction of the equipment.

Typically, to address the above issues, air compressors on which dryers have been mounted have been developed.

The dryer is disposed between the head part and the air tank and is filled with a desiccant, such as silica gel.

Thus, compressed air generated from the head part and flow into the dryer is dehydrated while passing through the desiccant and then flow into the air tank.

However, since the typical dryers are requiring the replacement of the desiccant when it becomes saturated with absorbed moisture, it leads to high operating costs.

Additionally, it is difficult to accurately determine the replacement timing of the desiccant, which, if the replacement timing is missed, there is a problem that the compressed air containing moisture flows into the air tank.

### PRIOR ART DOCUMENT

### Patent Document

(Patent Document 1) Korean Patent Publication No. 10-1730087

### SUMMARY

The present disclosure provides a moisture centrifuge dryer capable of removing moisture contained in compressed air by using centrifugation without using an additional desiccant.

The present disclosure also provides a moisture centrifuge dryer which is permanently usable without replacing an desiccant.

The present disclosure also provides a moisture centrifuge dryer capable of removing moisture contained in compressed air in multi-stages.

The object of the present invention is not limited to the problems mentioned above, and other problems not mentioned will be clearly understood by those skilled in the art from the description below.

In accordance with an exemplary embodiment of the present invention, a moisture centrifuge dryer includes a moisture removing part connected to a head part of an air compressor to remove moisture from compressed air introduced therein; and a compressed-air discharge part coupled to an upper end of the moisture removing part and connected to an air tank of the air compressor to guide the compressed air discharged upward from the moisture removing part, thereby discharging the compressed air toward the air tank, wherein the moisture removing part is configured to centrifugate moisture from the compressed air to remove the moisture from the compressed air.

The moisture removing part may include a centrifuge tube connected to the head part and configured to circumferentially guide the compressed air introduced from the head part to separate the moisture from the compressed air by using centrifugal force and guide and discharge the compressed air, from which the moisture is removed, upward; and a moisture guiding discharge tube coupled to the centrifuge tube and disposed below the centrifuge tube and configured to circumferentially guide the compressed air together with the centrifuge tube, and then guide downward and discharge the moisture, which is separated from the compressed air by the centrifugal force and then is coagulated on an inner circumferential surface of the centrifuge tube.

The moisture removing part may further include a residual moisture removing filter coupled to the centrifuge tube, disposed in the centrifuge tube, and configured to filter the compressed air which is introduced into the centrifuge tube to flow upward, thereby removing residual moisture from the compressed air.

### BRIEF DESCRIPTION OF THE DRAWINGS

Exemplary embodiments can be understood in more detail from the following description taken in conjunction with the accompanying drawings, in which:

FIG. 1 is a perspective view of a state in which a moisture centrifuge dryer is mounted on an air compressor in accordance with an exemplary embodiment of the present invention;

FIG. 2 is a front view of the moisture centrifuge dryer in accordance with an exemplary embodiment of the present invention;

FIG. 3 is a cross-sectional view taken along line III-III of FIG. 2;

FIG. 4 is an exploded view of a moisture removing part of FIG. 2;

FIG. 5 is a perspective view of a state in which a centrifuge tube is viewed from the bottom side in accordance with an exemplary embodiment of the present invention;

FIG. 6 is a perspective view of a state in which the centrifuge tube is viewed in a plane in accordance with an exemplary embodiment of the present invention; and

FIG. 7 is an exploded view of a compressed-air discharge part of FIG. 2.

### DETAILED DESCRIPTION OF EMBODIMENTS

Hereinafter, embodiments will be described in detail with reference to the accompanying drawings. However, various changes may be made to the embodiments, so the scope of rights of the patent application is not restricted or limited by these embodiments. It should be understood that all changes, equivalents, or substitutes for the embodiments are included in the scope of rights.

Specific structural or functional descriptions of the embodiments are disclosed for illustrative purposes only and may be modified and implemented in various forms. Thus, the embodiments are not limited to the specific disclosed form, and the scope of the present specification includes changes, equivalents, or substitutes included in the technical spirit.

The terms such as first or second may be used to describe various components, but these terms should be interpreted only for the purpose of distinguishing one component from another component. For example, a first component may be named a second component, and similarly, a second component may also be named a first component.

It will also be understood that when an element is referred to as being ‘connected to’ another element, it can be directly connected to the other element, or intervening elements may also be present.

The terms used in the embodiments are for descriptive purposes only and should not be construed as limiting. The terms of a singular form may include plural forms unless referred to the contrary. In this specification, it should be understood that the terms such as “comprise/include” or “have” are intended to designate the presence of features, numbers, steps, operations, components, parts, or combinations thereof described in the specification, but does not exclude in advance the possibility of the existence or addition of elements, numbers, steps, operations, components, parts, or combinations thereof.

In addition, when describing with reference to the accompanying drawings, identical components will be assigned the same reference numerals regardless of the reference numerals, and overlapping descriptions thereof will be omitted. In describing the embodiments, if it is determined that detailed descriptions related to known technologies may unnecessarily obscure the gist of the embodiments, the detailed descriptions are omitted.

Advantages and features of the present disclosure, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

In the embodiments of the present invention, unless otherwise defined, all terms used herein, including technical or scientific terms, are the same as those commonly understood by a person of ordinary skill in the technical field to which the present invention pertains. Terms defined in commonly used dictionaries should be interpreted as having meanings consistent with the meanings they have in the context of the relevant technology. In this description, unless defined clearly, terms are not ideally, excessively construed as formal meanings.

Since a shape, a ratio, an angle, a number, etc., which are shown in the accompanying drawings are exemplarily illustrated, the present disclosure is not limited thereto. Moreover, detailed descriptions related to well-known functions or configurations will be ruled out in order not to unnecessarily obscure subject matters of the present disclosure. When ‘comprising’, ‘having’, ‘consisting of’, etc. are used, other components can be added unless ‘only’ is used. Even when a component is explained in singular number they may be interpreted as plural number.

In interpretation of the components, even though separate explicit expressions are not provided, they are to be interpreted as including general tolerance.

When positional relation of two portions is explained by ‘on’, ‘upper’, ‘lower’, ‘beside’, etc., one or more components may be positioned between two portions unless ‘just’ is not used. When portions are connected by ‘or’, the portions are interpreted as including ‘alone’ as well as ‘combination thereof’ but when portions are connected by ‘or’, ‘one of’, portions are interpreted as ‘alone’.

When an element or layer is referred to as “on” another element or layer, it includes instances where the element or layer is directly on top of or intervening with another element. Like reference numerals refer to like elements throughout.

The size and thickness of each component shown in the drawings are shown for convenience of explanation, and the present invention is not necessarily limited to the size and thickness of the components shown.

Each feature of the various embodiments of the present invention can be partially or fully coupled or combined with each other, and as can be fully understood by those skilled in the art, various technical interconnections and operations are possible. Also, the embodiments may be independently performed with respect to each other or performed in combination of each other.

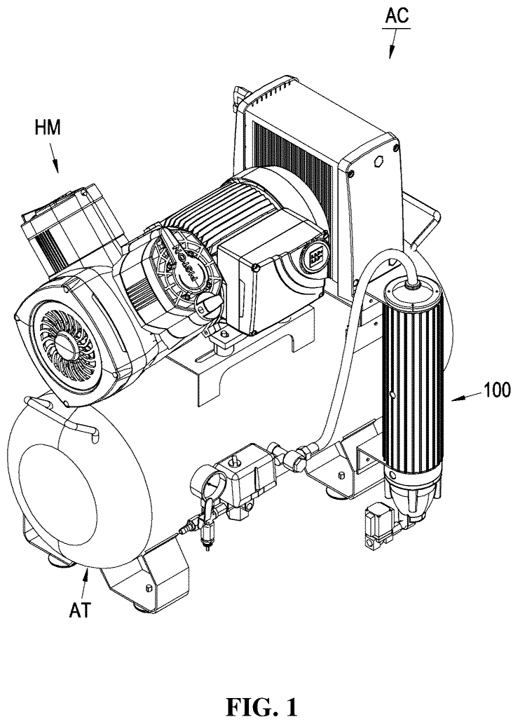

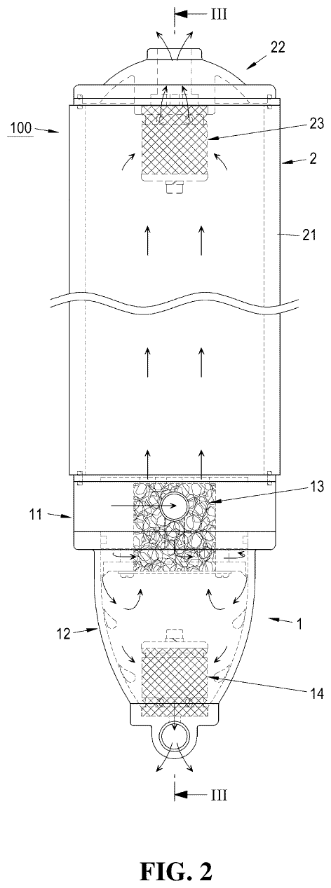

FIG. 1 is a perspective view of a state in which a moisture centrifuge dryer is mounted on an air compressor in accordance with an exemplary embodiment of the present invention, and FIG. 2 is a front view of the moisture centrifuge dryer in accordance with an exemplary embodiment of the present invention.

Referring to FIGS. 1 and 2, a moisture centrifuge dryer 100 includes a moisture removing part 1 and a compressed-air discharge part 2.

The moisture removing part 1 is connected to a head part HM of an air compressor AC.

Here, definition in which the moisture removing part 1 is connected to the head part HM may include definitions in which the moisture removing part 1 is directly connected to the head part HM, as well as, in which the moisture removing part 1 is indirectly connected to the head part HM through other components connected to the head part HM.

For example, the moisture removing part 1 is directly connected to the head part HM, or indirectly connected to the head part HM through a cooling fan connected to the head part HM.

The moisture removing part 1 removes moisture from the compressed-air introduced therein by using a physical action.

More particularly, the moisture removing part 1 is configured to centrifugate moisture from the compressed air to remove the moisture from the compressed air.

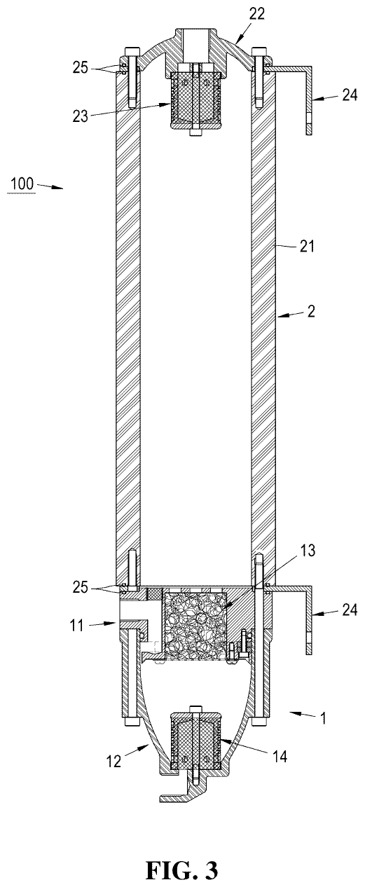

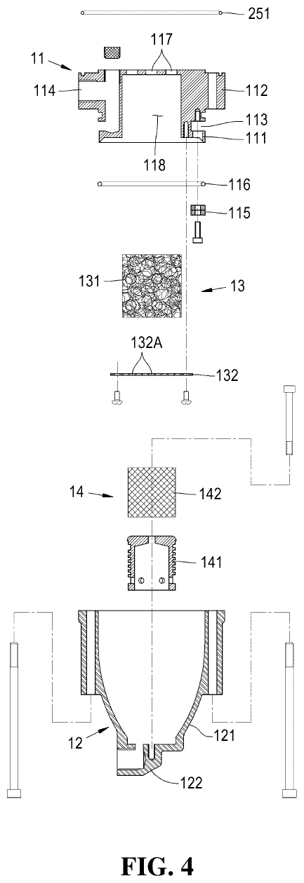

FIG. 3 is a cross-sectional view taken along line III-III of FIG. 2, and FIG. 4 is an exploded view of a moisture removing part of FIG. 2.

Referring to FIGS. 3 and 4, the moisture removing part 1 may include a centrifuge tube 11 and a moisture guiding discharge tube 12.

The centrifuge tube 11 may be connected to the head part HM.

The centrifuge tube 11 may circumferentially guide the compressed-air flow into the head part HM to separate moisture from the compressed-air using centrifugal force and then guide and discharge the compressed-air from which the moisture is removed, upward.

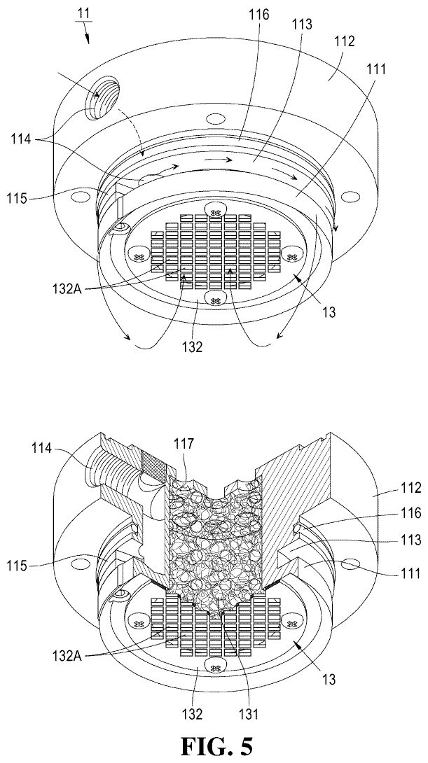

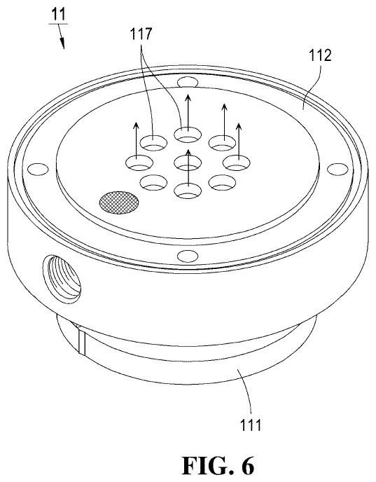

FIG. 5 is a perspective view of a state in which a centrifuge tube is viewed from a bottom side in accordance with an exemplary embodiment of the present invention, and FIG. 6 is a perspective view of a state in which a centrifuge tube is viewed in a plane in accordance with an exemplary embodiment of the present invention.

Referring to FIGS. 4 to 6, the centrifuge tube 11 may include a first tube body 111, a second tube body 112, a centrifuge guiding groove 113, an air inflow hole 114, an air-flow blocking block 115, a sealing ring 116, an air discharge hole 117, and a filter accommodation groove 118.

The first tube body 111 may be accommodated in the moisture guiding discharge tube 12.

The first tube body 111 may have an outer diameter smaller than an inner diameter of the moisture guiding discharge tube 12.

Here, a gap in which the moisture condensed on an inner circumferential surface of the moisture guiding discharge tube 12 and the dehydrated compressed-air flow downward may be defined between an outer circumferential surface of the first tube body 111 and an inner circumferential surface of the moisture guiding discharge tube 12.

The second tube body 112 may be disposed outside the moisture guiding discharge tube 12 and supported by an upper end of the moisture guiding discharge tube 12 and coupled to the head part HM.

The centrifuge guiding groove 113 may be recessed in the outer circumferential surface of the first tube body 111.

The centrifuge guiding groove 113 may circumferentially guide the compressed-air introduced therein.

The air inflow hole 114 may pass through the second tube body 112 and the first tube body 111 to allow the head part HM to communicate with the centrifuge guiding groove 113.

The air inflow hole 114 may guide the compressed-air flow from the head part HM to the centrifuge guiding groove 113.

For example, the air inflow hole 114 may include a first hole recessed in a predetermined depth in a radial direction with respect to the second tube body 112 and a second hole recessed in a predetermined depth in a central-axis direction of the second tube body 112 to communicated with the centrifuge guiding groove 113. Here, since the second hole is recessed from a top surface of the second tube body 112, a shield member for shielding a portion of the second hole may be coupled to an upper portion of the second hole.

The air-flow blocking block 115 may be coupled to the first tube body 111 and disposed in one section of the centrifuge guiding groove 113.

The air-flow blocking block 115 may contact to the inner circumferential surface of the moisture guiding discharge tube 12 to block one section of the centrifuge guiding groove 113.

Thus, the air-flow blocking block 115 has an inner surface having an arc shape corresponding to that of the centrifuge guiding groove 113 to contact the centrifuge guiding groove 113. The air-flow blocking block 115 has an outer surface having an arc shape corresponding to that of the inner circumferential surface of the moisture guiding discharge tube 12 to contact the inner circumferential surface of the moisture guiding discharge tube 12.

Thus, the compressed air from which moisture is removed while being circumferentially moved along the centrifuge guiding groove 113 and the inner circumferential surface of the moisture guiding discharge tube 12 is guided downward by the air-flow blocking block 115 when the compressed air reaches a section where the centrifuge guiding groove 113 is blocked by the air-flow blocking block 115, and then is discharged through a gap between the outer circumferential surface of the first tube 111 and the inner circumferential surface of the moisture guiding discharge tube 12.

The compressed air, having been moved along the inner circumferential surface of the moisture guiding discharge tube 12 in the circumferential direction, is guided downward by the air-flow blocking block 115 when it reaches the section where the centrifuge guiding groove 113 is blocked.

For example, the air-flow blocking block 115 may be coupled to the first tube body 111 by coupling means such as bolts.

The sealing ring 116 may be coupled to the outer circumferential surface of the first tube body 111 and then disposed above the centrifuge guiding groove 113.

The sealing ring 116 may be closely adhered to the inner circumferential surface of the moisture guiding discharge tube 12 to seal a gap between the first tube body 111 and the moisture guiding discharge tube 12.

The sealing ring 116 may be made of an elastic material such as rubber or silicone.

A plurality of air discharge holes 117 may be defined in the center of the centrifuge tube 11.

The air discharge holes 117 may upwardly guide and discharge the compressed air, which is introduced from a lower side of the first tube body 111 after moisture centrifugation.

The filter accommodation groove 118 may be recessed in a predetermined depth from a bottom surface of the first tube body 111 to communicate with the air discharge hole 117.

A residual moisture removing filter 13, which will be described below, may be accommodated in the filter accommodation groove 18.

Referring to FIGS. 3 and 4, the moisture guiding discharge tube 12 may be coupled to the centrifuge tube 11 and disposed below the centrifuge tube 11.

The moisture guiding discharge tube 12 may guide the compressed air in the circumferential direction together with the centrifuge tube 11, and simultaneously, may downwardly guide and discharge the moisture, which is separated from the compressed air by centrifugal force and then coagulated on an inner circumferential surface thereof.

That is, while the compressed air is introduced into the centrifuge tube 11 is discharged through a space between the outer circumferential surface of the centrifuge tube 11 and the inner circumferential surface of the moisture guiding discharge tube 12, the compressed air moves at high speed in the circumferential direction along the outer circumferential surface of the centrifuge tube 11 and the inner circumferential surface of the moisture guiding discharge tube 12. In this process, the moisture contained in the compressed air is centrifugated and coagulated on the inner circumferential surface of the moisture guiding discharge tube 12.

Then, the compressed air from which the moisture is removed flows downward through the gap defined between the outer circumferential surface of the centrifuge tube 11 and the inner circumferential surface of the moisture guiding discharge tube 12, and then is introduced into an inner central part of the centrifuge tube 11, and is discharged upward. Meanwhile, the moisture coagulated on the inner circumferential surface of the moisture guiding discharge tube 12 flows downward along the inner circumferential surface of the moisture guiding discharge tube 12 and then is discharged to the outside of the moisture guiding discharge tube 12.

The moisture guiding discharge tube 12 may include a discharge tube main body 121 and a drain port 122.

The discharge tube main body 121 may be coupled to the centrifuge tube 11.

The first tube body 111 may be accommodated in the discharge tube main body 121, and the second tube body 112 may be supported by an upper end of the discharge tube main body 121.

The discharge tube main body 121 may have an inner diameter of which a size is gradually reduced in an axis direction, and thus may guide downward the moisture coagulated on the inner circumferential surface thereof.

For example, the discharge tube main body 121 may be coupled to the centrifuge tube 11 by coupling means such as bolts.

The drain port 122 is disposed on a lower end of the discharge tube main body 121 to communicate with the discharge tube main body 121.

The drain port 122 may discharge the moisture, which is moved downward in the discharge tube main body 121, to the outside.

For example, a nipple tube and a solenoid valve are connected to the drain port 122. A nipple tube that guides the moisture discharged from the drain port 122 to the outside and a solenoid valve that is coupled to the nipple tube to selectively open and close an internal flow path, thereby discharging the moisture introduced into the nipple tube to the outside. Additionally, a silencer may be further connected to an end of the solenoid valve.

Referring to FIGS. 3 through 5, the moisture removing part 1 may further include a residual moisture removing filter 13.

The residual moisture removing filter 13 may be coupled to the centrifuge tube 11 and disposed inside the centrifuge tube 11.

The residual moisture removing filter 13 may filter the compressed air which is introduced into the centrifuge tube 11 to flow upward, thereby removing residual moisture from the compressed air.

That is, the moisture centrifuge dryer 100 in accordance with the present invention may firstly remove the moisture from the compressed air through the centrifuge tube 11 and secondly remove the moisture from the compressed air through the residual moisture removing filter 13 disposed in the centrifuge tube 11, and thereby perfectly removing the moisture in the compressed air.

The residual moisture removing filter 13 may include a wire bundle 131 and a filter support cover 132.

The wire bundle 131 may be accommodated in the filter accommodation groove 118 to filter residual moisture from the compressed air passing through the filter accommodation groove 118.

The wire bundle 131 may be made of a metallic material.

More specifically, the wire bundle 131 may have a structure in which stainless steel wires are entangled.

For example, the wire bundle 131 may filter moisture from the compressed air in a micron part.

The filter support cover 132 may be coupled to the bottom surface of the first tube body 111 to cover an entrance of the filter accommodation groove 118.

An air flow hole 132A to which the compressed air is introduced may be defined in the filter support cover 132.

For example, the filter support cover 132 may be coupled to the bottom surface of the first tube body 111 by coupling means such as bolts.

Referring to FIGS. 3 and 4, the moisture removing part 1 may further include a moisture impurity removing filter 14.

The moisture impurity removing filter 14 may be disposed in the moisture guiding discharge tube 12 to remove impurities from the moisture discharged to the outside of the moisture guiding discharge tube 12.

The moisture impurity removing filter 14 may include a filter support tube body 141 and a moisture impurity removing mesh 142.

The filter support tube body 141 may be coupled to the discharge tube main body 121 to communicate with the drain port 122, thereby guiding the moisture introduced therein to the drain port 122.

For example, the filter support tube body 141 may be coupled to the discharge tube main body 121 by coupling means such as bolts.

The moisture impurity removing mesh 142 may be coupled to and supported by an outer circumferential surface of the filter support tube body 141 to filter impurities from the moisture introduced into the filter support tube body 141

For example, the moisture impurity removing mesh 142 may be made of stainless steel and formed in a mesh structure.

Referring to FIGS. 1 to 3, the compressed-air discharge part 2 is coupled to an upper end of the moisture removing part 1 and connected to an air tank AT of the air compressor AC.

The compressed-air discharge part 2 guides the compressed air discharged upward from the moisture removing part 1 to discharge the compressed air toward the air tank AT.

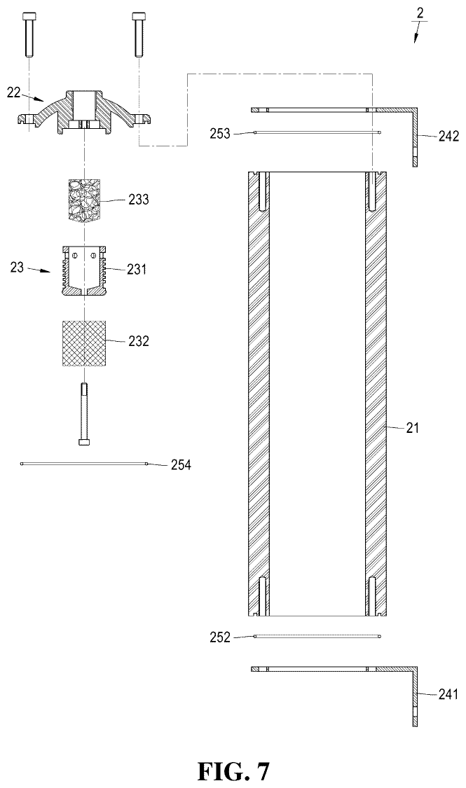

FIG. 7 is an exploded view of the compressed-air discharge part of FIG. 2.

Referring to FIGS. 3 and 7, the compressed-air discharge part 2 may include an air discharge guide tube 21, an upper shielding cover 22, and an auxiliary impurity removing filter 23.

The air discharge guide tube 21 may be coupled to an upper end of the moisture removing part 1.

The air discharge guide tube 21 may guide the moisture-removed compressed air discharged upward from the moisture removing part 1 to an upper side.

For example, the air discharge guide tube 21 may be coupled to the air discharge guide tube 21 and the moisture guiding discharge tube 12 by coupling means such as bolts that penetrate the moisture guiding discharge tube 12 and the centrifuge tube 11.

The upper shielding cover 22 may be coupled to an upper end of the air discharge guide tube 21 to shield an upper portion of the air discharge guide tube 21, and may communicate with the air tank AT.

The upper shielding cover 22 may discharge the compressed air introduced upwards in the air discharge guide tube 21 toward the air tank AT.

A hole may be defined in the center of the upper shielding cover 22 to allow the air tank AT to communicate with the internal space of the air discharge guide tube 21.

For example, the upper shielding cover 22 may be coupled to the air discharge guide tube 21 by coupling means such as bolts that penetrate the upper shielding cover 22 and then are coupled to the upper end of the air discharge guide tube 21.

The auxiliary impurity removing filter 23 may be coupled to the bottom surface of the upper shielding cover 22 and accommodated inside the air discharge guide tube 21.

The auxiliary impurity removing filter 23 may remove impurities from the compressed air discharged from the air discharge guide tube 21 to the upper shielding cover 22.

The auxiliary impurity removing filter 23 may include an auxiliary support tube body 231 and an auxiliary impurity removing mesh 232.

The auxiliary support tube body 231 may be coupled to the upper shielding cover 22 to communicate with the upper shielding cover 22, thereby guiding the compressed air introduced therein to the upper shielding cover 22.

For example, the auxiliary support tube body 231 may be coupled to the upper shielding cover 22 by coupling means such as bolts.

The auxiliary impurity removing mesh 232 may be supported by and coupled to an outer circumferential surface of the auxiliary support tube body 231.

The auxiliary impurity removing mesh 232 may filter impurities from the compressed air introduced into the auxiliary support tube body 231.

For example, the auxiliary impurity removing mesh 232 may be made of stainless steel and formed in a mesh structure.

The auxiliary impurity removing filter 23 may be configured to remove residual moisture from the compressed air from which impurities are removed.

The auxiliary impurity removing filter 23 may further include an auxiliary wire bundle 233.

The auxiliary wire bundle 233 may be accommodated inside the auxiliary support tube body 231 to filter residual moisture from the compressed air passing through the auxiliary support tube body 231.

The auxiliary wire bundle 233 may be made of a metallic material.

The auxiliary wire bundle 233 may be separated from the inside of the auxiliary support tube body 231, if necessary.

More specifically, the auxiliary wire bundle 233 may have a structure in which stainless steel wires are entangled.

For example, the auxiliary wire bundle 233 may filter moisture from the compressed air in a micron part.

Also, although not shown in the drawings, the compressed-air discharge part 2 may further include a high-performance purification filter (not shown).

The high-performance purification filter may be disposed on an outer surface of the auxiliary impurity removing filter 23 or may be disposed in place of the auxiliary impurity removing filter 23.

The high-performance purification filter may filter the compressed air discharged from the air discharge guide tube 21 to the upper shielding cover 22, to remove micron-sized fine particles from the compressed air.

For example, the high-performance purification filter may be a HEPA (High Efficiency Particulate Air) filter that removes 99.99% of particles sized 0.3 micrometers or larger, or a ULPA (Ultra Low Penetration Air) filter that removes 99.999% of particles sized 0.1 to 0.3 micrometers that cannot be filtered by the HEPA filter. However, the high-performance purification filter is not limited thereto, and may also be provided in a structure in which both HEPA and ULPA filters are provided.

Referring to FIGS. 3 and 7, the compressed-air discharge part 2 may further include a bracket 24 and a sealing ring 25.

The bracket 24 may include a first bracket 241 disposed between the centrifuge tube 11 and the air discharge guide tube 21 and coupled to the air compressor AC, and a second bracket 242 disposed between the air discharge guide tube 21 and the upper shielding cover 22 and coupled to the air compressor AC.

The sealing ring 25 may include a first sealing ring 251 made of an elastic material, coupled to the top surface of the centrifuge tube 11 and tightly attached to a bottom surface of the first bracket 241 to sealing a space between the centrifuge tube 11 and the first bracket 241; a second sealing ring 252 made of an elastic material, coupled to the bottom surface of the air discharge guide tube 21 and tightly attached to a top surface of the first bracket 241 to seal a space between the air discharge guide tube 21 and the first bracket 241; a third sealing ring 253 made of an elastic material, coupled to a top surface of the air discharge guide tube 21 and tightly attached to a bottom surface of the second bracket 242 to seal a space between the air discharge guide tube 21 and the second bracket 242; and a fourth sealing ring 254 made of an elastic material, coupled to a bottom surface of the upper shielding cover 22 and tightly attached to a top surface of the second bracket 242 to seal a space between the upper shielding cover 22 and the second bracket 242.

Although not shown in the drawings, this moisture centrifuge dryer 100 in accordance with the present invention may further include a moisture separation membrane.

The moisture separation membrane may be disposed in the residual moisture removing filter 13.

More specifically, the moisture separation membrane may be accommodated in the filter accommodation groove 118 and disposed in a multi-layer structure on top of the wire bundle 131.

Thus, the moisture separation membrane may perform additional multi-stage filtration on the compressed air flowing upwards in the centrifuge tube 11 through the wire bundle to completely separate residual moisture from the compressed air.

For example, the moisture separation membrane may be a microporous membrane made of at least one material selected from polyimide, polyester, or cellulose triacetate

Also, although not shown in the drawings, the moisture centrifuge dryer 100 in accordance with the present invention may further include a humidity sensor installed in the air discharge guide tube 21 to detect the internal humidity of the air discharge guide tube 21, and an opening and closing valve disposed in the air discharge guide tube 21 to open and close a flow path of the air discharge guide tube 21 according to the humidity information detected by the humidity sensor.

The opening and closing valve may include an opening and closing plate rotatably coupled to the air discharge guide tube 21 to selectively open and close an internal flow path of the air discharge guide tube 21, and an opening and closing plate driving actuator disposed outside the air discharge guide tube 21 to rotate the opening and closing plate.

The opening and closing plate driving actuator may be interlinked with the humidity sensor to operate the opening and closing plate based on the humidity information detected by the humidity sensor, thereby opening and closing the flow path of the air discharge guide tube 21.

For example, when the humidity information detected by the humidity sensor is defined within a preset threshold range, the opening and closing plate driving actuator may position the opening and closing plate in a first state to open the flow path of the air discharge guide tube 21. Conversely, when the humidity information detected by the humidity sensor is not defined within the preset threshold range, the opening and closing plate driving actuator may position the opening and closing plate in a second state to close the flow path of the air discharge guide tube 21.

According to the embodiment of the present invention, since moisture may be removed from compressed air by centrifugation without using a desiccant, maintenance costs may be reduced and permanent use without the need for desiccant replacement may be possible.

Additionally, after removing moisture through centrifugation in the centrifuge tube 11, residual moisture in the compressed air may be further removed through the residual moisture removing filter 13 accommodated in the centrifuge tube 11, and thus, moisture may be completely removed from the compressed air.

Moreover, since the auxiliary impurity removing filter 23 may be disposed below the upper shielding cover 22 to remove impurities and residual moisture from the compressed air, it not only prevents the introduction of impurities into the air tank AT but also maximizes the moisture removing performance of the dryer.

The effects according to the present invention are not limited to the details exemplified above, and further various effects are included within the present invention.

Although embodiments of the present invention have been described in more detail with reference to the accompanying drawings, the present invention is not necessarily limited to these embodiments, and various modifications may be made without departing from the technical spirit of the present invention. Thus, the embodiment of the present invention is to be considered illustrative, and not restrictive, and the technical spirit of the present invention is not limited to the foregoing embodiment. Therefore, the embodiments described above should be understood in all respects as illustrative and not restrictive. Therefore, the scope of the present disclosure is defined not by the detailed description of the invention but by the appended claims, and all differences within the scope will be construed as being included in the present disclosure.

Therefore, other implementations, other embodiments, and equivalents of the claims also fall within the scope of the following claims.

What is claimed is:

1. A moisture centrifuge dryer comprising:
a moisture removing part connected to a head part of an air compressor to remove moisture from compressed air introduced therein; and
a compressed-air discharge part coupled to an upper end of the moisture removing part and connected to an air tank of the air compressor to guide the compressed air discharged upward from the moisture removing part, thereby discharging the compressed air toward the air tank,
wherein the moisture removing part is configured to centrifugate moisture from the compressed air to remove the moisture from the compressed air.

2. The moisture centrifuge dryer of claim 1, wherein the moisture removing part comprises;
a centrifuge tube connected to the head part and configured to circumferentially guide the compressed air introduced from the head part to separate the moisture from the compressed air by using centrifugal force and guide and discharge the compressed air, from which the moisture is removed, upward; and
a moisture guiding discharge tube coupled to the centrifuge tube and disposed below the centrifuge tube and configured to circumferentially guide the compressed air together with the centrifuge tube and guide and discharge the moisture, which is separated from the compressed air by the centrifugal force and is coagulated on an inner circumferential surface of the centrifuge tube, downward.

3. The moisture centrifuge dryer of claim 2, wherein the moisture removing part further comprises a residual moisture removing filter coupled to the centrifuge tube, disposed in the centrifuge tube, and configured to filter the compressed air which is introduced into the centrifuge tube to flow upward, thereby removing residual moisture from the compressed air.
